(19) United States
(12) Patent Application Publication
(10) Pub. No.: US 2005/0175440 A1
(43) Pub. Date: Aug. 11, 2005

(54) Device for stacking sheets, especially sheets of paper or cardboard transported by a stream feeder, onto pallets

(76) Inventor: Albert Stitz, Kurten (DE)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/484,477

(22) PCT Filed: Jun. 19, 2002
(86) PCT No.: PCT/EP02/06761

(30) Foreign Application Priority Data
Jul. 19, 2001 (DE) 101 34 423.6

(51) Int. Cl. B65G 57/22

(52) U.S. Cl. 414/792

(57) ABSTRACT

In order to stack sheets (1) of paper or cardboard transported by a stream feeder onto pallets (4), devices are known which comprise a vertically fixed transport mechanism (2) for the sheets (1), placed above the ground, above the maximum stack height, and a stacking platform (5) which can be raised and lowered, and on which the piles (3) are formed. Ejection rolls (10) and separating shoes (11) are arranged in the form of stack-forming elements, behind the transport mechanism (2), acting on the longitudinal edges of a sheet (1). According to the invention, the separating shoes (11) are formed in a cuneiform manner with a separating edge extending upwards from a tip situated on the entrance side in the displacement direction of the sheets. Said shoes are arranged in the displacement direction of the sheets, behind the ejection rolls (10), in such a way that the separating edge starts below the ejection height of the ejection rolls (10).

### TECHNICAL FIELD

The invention relates to a device for stacking sheets, especially sheets of paper or cardboard transported by a stream feeder, onto pallets, with a vertically fixed feed mechanism for the sheets, situated above the ground at a height above the maximum stack height, with a stacking platform that can be raised and lowered and on which the stacks are formed, and with at least one ejection roll and at least one separating shoe that are arranged downstream from the feed mechanism.

### STATE OF THE ART

Devices for crosscutting sheets of paper or cardboard are known to end in a stacking device by means of which the sheets produced by crosscutting are stacked with precisely aligned edges. Normally, a conveyor belt that functions as a stream feeder transports the sheets to the stacking station where they are stacked onto pallets that are placed on a stacking platform. The stacking platform is suspended in the frame of the stacking device so that it can be raised up to the area of the feeding level of the sheets and lowered to the floor area. One stack or else several stacks are formed next to each other on the stacking platform if the sheets of paper or cardboard are additionally divided into several individual sheets in the longitudinal direction before being crosscut.

Downstream from the feed mechanism and in the stacking station, it is a known procedure to arrange stacking elements that ensure trouble-free feeding to the stacking station as well as a precise alignment of the edges on the stack or stacks. The stacking elements comprise ejection rolls that are arranged at regular intervals crosswise over the working width downstream from the feed mechanism immediately above the feeding level at a certain distance from each other. They effectuate the transfer of the sheets from the feeder to the stacking station. Moreover, downstream from the feed mechanism, there are separating shoes that impart a stabilizing curvature to the longitudinal edges of each sheet and, in the case of a multiple-line operation, ensure separate feeding of two adjacent sheets to the stacking station. For this function, the separating shoes are arranged in the area between two longitudinal edges of two adjacent sheets. Moreover, on each longitudinal, edge of a stack that is being formed in the stacking station, there is an upright separating plate extending in the sheet-travel direction by means of which the edge of each stack is aligned. Normally, the separating plates are made to vibrate so as to ensure the proper alignment of the sheets on a stack.

World patent WO 00/20315 describes a stacking device of this type in which the separating shoes are arranged upstream from the ejection rolls. The separating shoes have an edge that rises on each longitudinal side by means of which the longitudinal, edges of two adjacent sheets are bent upwards away from each other.

### DESCRIPTION OF THE INVENTION

The invention is based on the objective of improving a stacking device of the generic type in such a way that sheets of paper or cardboard can be stacked trouble-free with precisely aligned edges at high speed.

This objective is achieved in that the separating shoes are configured so as to be wedge-shaped with a separating edge running from an inlet-side tip upwards in the sheet-travel direction and are arranged in the sheet sheet-travel direction downstream from the ejection rolls in such a way that the separating edge starts below the ejection height of the ejection rolls.

The configuration and arrangement of the separating shoes cause the front edge of the sheet—without its being deflected upwards—to strike the separating shoe so that it immediately imparts a curvature inwards crosswise to the sheet-travel direction, along the longitudinal edges of said sheet. This curvature on the longitudinal edges, referred to as cupping, stabilizes the sheet for the further forward movement by preventing its front part from bending down.

The subclaims contain embodiments of a device according to the invention that are preferred since they are especially advantageous:

According to claim 2, the separating shoes and ejection rolls that act on a longitudinal edge are attached to a shared, crosswise adjustable holder. This is an advantageous construction since the separating shoes as well as the ejection rolls have to be positioned along the course of the longitudinal edges between two sheets.

In the advantageous embodiment according to claim 3, each separating shoe is attached to a holding plate on which a separating plate is suspended and which is connected to a shaking drive. In this manner, the separating shoe is made to vibrate by means of the shaking drive of the separating element. This considerably improves the stack formation and the product flow since it facilitates the sliding of the sheets down onto the stack.

An especially advantageous embodiment is the one according to claim 4 in which the ejection rolls are attached to a holding plate to which a vibration-uncoupled second holding plate is attached. The second holding plate holds the separating shoe and the ejection rolls and it is connected to a shaking drive. The stack-forming elements that act on one longitudinal edge can thus be positioned crosswise by means of a shared traveling drive, and they can also be raised and lowered by a shared lifting drive.

### BRIEF DESCRIPTION OF THE DRAWING

The drawing serves to explain the invention with respect to a simplified embodiment:

FIG. 1 is a schematic representation of the side view of a stacking device.

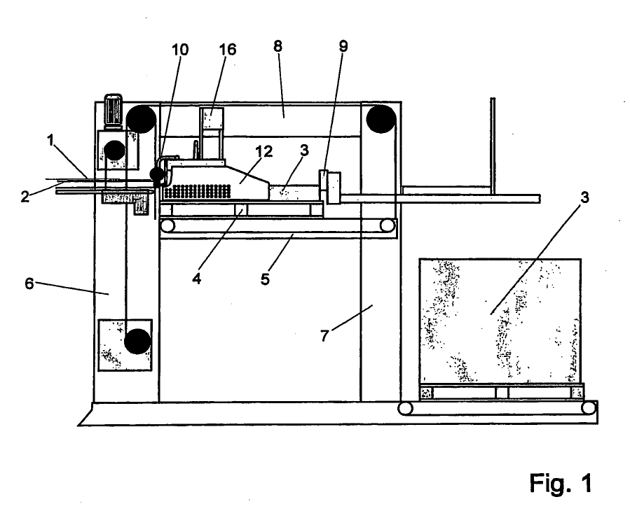

FIG. 2 is an enlarged representation of the side view of the stack-forming elements acting on the longitudinal edges of the sheet.

FIG. 3 is a view of the stack-forming elements opposite from the sheet-travel direction.

### WAYS TO EXECUTE THE INVENTION

The stacking device shown in the figures serves to stack sheets 1 of paper or cardboard that are continuously fed by a stream feeder and that were produced with a crosscutting machine. The sheets 1 are fed to the stacking station by a feed mechanism 2 that is configured as a conveyor belt and that is arranged at a fixed vertical position above the ground at a height above the maximum stack height. The stacks 3 are formed on pallets 4 that lie on a stacking platform 5. The stacking platform 5 is suspended in the frame of the stacking device so that it can be raised up to the area of the feeding level of the sheets 1 and lowered to the floor area.

The frame of the device comprises two inlet-side posts 6 and two outlet-side posts 7 that are arranged outside of the working width on the two longitudinal sides of the machine and that are connected to each other at their upper ends by longitudinal beams 8 and transverse beams. The posts 6, 7 define the limits of the stacking station.

In the area of the feeding level of the sheets 1, there are various elements that serve for a trouble-free feeding of the sheets 1 to the stacking station and for their edge-aligned placement on the stack 3. Up to four stacks 3 are formed next to one another at the same time. Therefore, the crosscutting machine additionally cuts the web of paper or cardboard —from which the sheets 1 are made—into individual webs by making an appropriate number of longitudinal cuts before the crosscutting operation.

As the stack-forming elements, the device comprises a stop plate 9 extending crosswise over the working width of the device, whereby the leading edges of the sheets are aligned against said stop. In order to adjust the position of the stop plate 9 in the longitudinal direction for different paper lengths, it is suspended so as to be longitudinally slidable at the rear of the stacking station.

Downstream from the feed mechanism 2, crosswise over the working width, there are ejection rolls 10 arranged at a distance from each other, by means of which the sheets 1 are transferred to the stacking station. In the sheet-travel direction, immediately downstream from the ejection rolls 10, there are separating shoes 11 by means of which the longitudinal edges of two adjacent sheets 1 are bent upwards. The curvature of a sheet 1 along its longitudinal edges leads to so-called cupping, which stabilizes the sheet 1 and, at the same time, brings about a reliable separation of two adjacent sheets 1.. Each separating shoe 11 is configured so as to be wedge-shaped with an inlet-side tip, whereby a separating edge runs upwards from the tip in the sheet-travel direction. The essential aspect for the invention is that the separating shoes 11 are arranged in the sheet-travel direction behind the apex line of the ejection rolls 10 in such a way that their separating edge starts below the ejection height of the ejection rolls 10. The ejection height corresponds to the height at which a sheet 1 is transported further by the ejection rolls 10.

Downstream from each separating shoe 11, there is a separating plate 12 that extends upright and in the sheet-travel direction. The separating plates 12 have the function of laterally guiding and aligning the sheets 1 in order to place them with precisely aligned edges on the stack 3. Therefore, said separating plates are arranged in the stacking station between two stacks 3 and on the two outer longitudinal edges of the outer stack 3. The separating plates 12 are each-connected to a pneumatic or electric motor vibrator 13 that serves as the shaking drive, by means of which they are vibrated at a frequency of several Hertz. The stack-forming elements that act along a longitudinal edge of the sheet at the side or on two adjacent longitudinal sheet edges are advantageously suspended on a shared holder that is adjustable crosswise and heightwise. In the present embodiment, the elements 10, 11, 12 are suspended on a holding plate 14 that is attached to the end of two guide rails 15. At their upper end, the guide rails 15 are attached to a carriage 16 that is mounted on a crossbar so as to slide crosswise. A piston-cylinder unit 17, likewise attached to the carriage 16, makes it possible to raise the elements out of their working position into an inactive position above the stack 3.

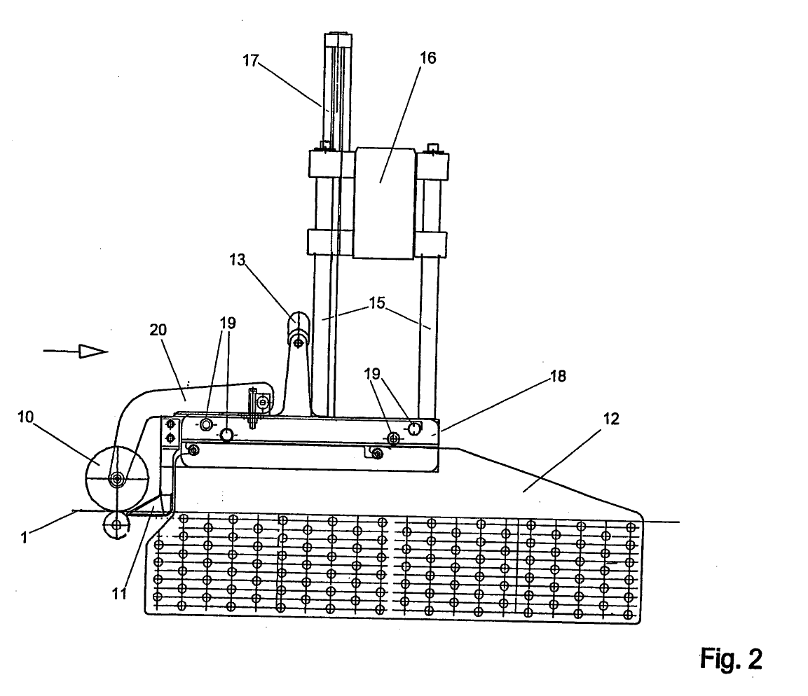

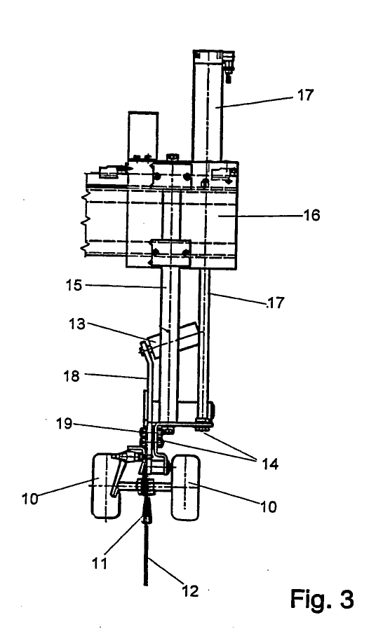

Attached to the holding plate 14, there is a second holding plate 18 that is arranged in the front in FIG. 2 and to the left of the holding plate 14 in FIG. 3. The second holding plate 18 is attached to the holding plate 14 exclusively by means of rubber elements 19 so that the two holding plates 14, 18 are vibration-uncoupled from each other. Due to the vibration-uncoupled suspension, the vibrator 13 attached to the second holding plate 18 cannot cause the holding plate 14 to vibrate. The separating plate 12 and the separating shoe 11 are connected to the holding plate 18 that vibrates during operation, so that they are made to vibrate together. The vibration of the separating shoes 11 causes the sheets 1 to slide more easily downward onto the stack 3. In contrast, the outer ejection rolls 10 are attached via a bearing bracket 20 to the non-vibrating holding plate 14. Therefore, they are not made to vibrate by the vibrator 13.

The shared suspension of the ejection roll 10, of the separating plate 12 and of the separating shoes 11 has the great advantage that these elements can be adjusted cross-wise by one single shared traversing drive and they can be raised and lowered by a shared lifting drive (piston-cylinder unit 17).

1. A device for stacking sheets transported by a stream feeder onto pallets, the device comprising:
(a) a vertically fixed feed mechanism situated above the ground at a height above a maximum stack height;
(b) a stacking platform capable of being raised and lowered and on which a stack of sheets is formed; and,
(c) at least one ejection roll and at least one separating shoe that are each arranged downstream from the feed mechanism,
wherein the separating shoes are wedge-shaped with a separating edge running from an inlet-side tip upwardly in a direction of sheet travel and are arranged in the sheet-travel direction downstream from the ejection roll in such a way that the separating edge starts below an ejection height of the ejection roll.

2. The device of claim 1, wherein the separating shoes and ejection rolls are attached to a shared, crosswise adjustable holder.

3. The device of claim 1, a wherein the separating is shoes are attached to a first holding plate (18).

4. The device of claim 3, wherein the first holding plate (18) is attached to a second holding plate so as to be vibration-uncoupled.

5. The device of claim 3, wherein a separating plate is attached to the first holding plate.

6. The deadline of claim 3, further comprising a shaking drive attached to the first holding plate.

7. The device of claim 4, wherein the ejection rolls are attached to the second holding plate.
